(19) United States
(12) Patent Application Publication
(10) Pub. No.: US 2011/0061047 A1
(43) Pub. Date: Mar. 10, 2011

(54) Licensing Software and Licensing Propagation Mechanism for Embedded Systems in Chassis and Stacked Environments

(75) Inventors: Srinivas Tyamagondlu, Santa Clara, CA (US); Yogesh Petkar, Woodland Hills, CA (US); Surajit Bhattacharya, Thousand Oaks, CA (US); Tao Shen, Newbury Park, CA (US)

(73) Assignee: ALCATEL LUCENT, Paris (FR)

(21) Appl. No.: 12/554,022

(22) Filed: Sep. 4, 2009

(51) Int. Cl. G06F 9/445

(52) U.S. Cl. 717/177

(57) ABSTRACT

A method of validating a license for a software application installed on a switch includes receiving a license file generated to provide a license for the software application, in which the license file contains a license key and license information for the switch, installing the license file on the switch to activate the license, validating the license internally on the switch using the license key within the license file and storing the license information associated with the license on the switch.

### BACKGROUND OF THE INVENTION

1. Technical Field of the Invention

The present invention relates in general to software licensing mechanisms, and in particular, to software licensing mechanisms for switches in chassis and stacked environments.

2. Description of Related Art

A software license is a legal instrument governing the usage or redistribution of copyright protected software. A typical software license grants an end-user permission to use one or more copies of a software application. License validation is a procedure of verifying that the software license is valid and being used in accordance with the end-user agreement.

During a typical software license validation process, upon initialization of the software application, the software application prompts the user to enter the user's name, a license key that can be found on the package containing the software and other information needed to validate the license. The entered information and other pertinent information, such as the name and version of the software application for which the license is being validated and a unique identifier of the device from which the validation request is being sent, is sent to a validation server. The validation server performs the validation of the license and transmits a message back to the device indicative of whether or not the license is valid.

Such software validation processes are sufficient for personal computer-based applications and other applications where security of the validation is not a concern. However, in networking applications, where license validation of software applications installed on switching devices is required, performing validation at a remote validation server may not be desirable.

### SUMMARY OF THE INVENTION

Embodiments of the present invention provide a computer readable media within a switch having computer executable instructions thereon to perform a method of validating a license. The method includes receiving a license file generated to provide a license for a software application installed on the switch, in which the license file contains a license key and license information for the switch, installing the license file on the switch to activate the license, validating the license internally on the switch using the license key within the license file and storing the license information associated with the license on the switch.

In one embodiment, the license file contains multiple license keys, each for use in validating a respective license for each of a plurality of different software applications installed on the switch. In another embodiment, the license file contains multiple license keys, each for use in validating a respective license for each of a plurality of different switches. In a further embodiment, if the license is a demo license and the license information includes a time period within which the demo license is valid, the method further includes periodically determining whether the time period has expired, and if so, informing the software application of the expiration of the demo license.

Embodiments of the present invention also provide a switch having a software application installed thereon for which a license is needed. The switch includes a processor for receiving a license file generated to provide the license for the software application, in which the license file contains a license key and license information. The processor further installs the license file on the switch to activate the license and validates the license using the license key within the license file. The switch further includes a memory for storing the license information associated with the license.

In one embodiment, the switch is a switch modular chassis and is coupled to a network to receive the license file from a network management station that also provides the license file to multiple switch modular chassis coupled to the network. In another embodiment, the switch is a stackable switch configured to operate with additional stackable switches as a single switch, and further includes a network interface card that is coupled to both a network to receive the license file from a switch administration device and to the additional stackable switches to provide the license file to the additional stackable switches.

In a further embodiment, the license key is associated with a unique combination of a switch network address, switch serial number and a license number for the license. In yet still a further embodiment, the license key is a 40 character encrypted string.

Embodiments of the present invention further provide a method for obtaining licenses for a software application installed on multiple switches within a network. The method includes accessing, by a processor, a license generation website for the licenses, uploading, by the processor, a file containing multiple entries to the website, in which each of the entries includes a respective authorization code for each of the multiple switches, receiving a single license file containing a respective license key for each of the entries in the file, each of the license keys for use in validating a respective license for the software application on each of the multiple switches and distributing the license file to the multiple switches for installation and activation of the licenses thereon.

### BRIEF DESCRIPTION OF THE DRAWINGS

A more complete understanding of the present invention may be obtained by reference to the following detailed description when taken in conjunction with the accompanying drawings wherein:

FIG. 1 illustrates an exemplary system for obtaining and validating a license for a software application within a switch, in accordance with embodiments of the present invention;

FIG. 2 illustrates an exemplary switch for validating one or more licenses for software applications installed on the switch, in accordance with embodiments of the present invention;

FIG. 3 illustrates a chassis environment for propagating licenses, in accordance with embodiments of the present invention;

FIG. 4 illustrates a stacked environment for propagating licenses, in accordance with embodiments of the present invention;

FIG. 5 is a flow diagram illustrating an exemplary process for obtaining and propagating a license, in accordance with embodiments of the present invention; and

FIG. 6 is a flow diagram illustrating an exemplary process for installing and validating a license, in accordance with embodiments of the present invention.

### DETAILED DESCRIPTION OF THE DRAWINGS

FIG. 1 illustrates an exemplary system 10 for obtaining and validating a license for a software application within a switch 20, in accordance with embodiments of the present invention. The system 10 includes a switch administration device 40 coupled to a license generator 70 via a communication network 60. The switch administration device 40 is further coupled to the switch 20 either directly or via a communication network. In other embodiments, the switch administration device 40 may reside within the switch 20.

The switch 20 is a computer networking device that connects network segments within a network. For example, the switch 20 may be a packet switch within a packet-switched network or a circuit switch within a circuit-switched network. In addition, the switch may be a network bridge that processes and routes data at the data link layer (layer 2, i.e., within the Media Access Control (MAC) sublayer of the data link layer) of the OSI model or may be a multilayer switch that additionally process data at the network layer (layer 3 and above). The switch 20 may also couple to different types of networks, including, but not limited to, Ethernet, Fibre Channel, ATM, ITU-T and 802.11.

The switch 20 has one or more software applications installed thereon to operate the switch 20. For example, the switch 20 may have a Multi-Label Protocol Switching (MPLS) software application installed thereon to enable the switch to send and receive data using MPLS. The switch 20 may be pre-loaded with software applications from the manufacturer and/or software applications may be later installed by the customer. One or more of these software applications may require a license for use thereof on the switch 20. In accordance with embodiments of the present invention, as will be described in more detail below, a license can be obtained from the license generator 70 and validated internally on the switch 20.

As shown in FIG. 1, the switch 20 is controlled and operated by a switch administrator (customer) using switch administration device 40. For example, the switch administration device 40 can download software applications, files and other data onto the switch 20 and configure various settings of the switch 20 to ensure that the switch 20 is operating in accordance with the customer's specifications. Therefore, the switch administration device 40 is coupled to an external network 60 to obtain software applications, files and other data for the switch 20 and to provide information related to the switch 20 to the external network 60.

The switch administration device 40 includes a processor 42, memory 44 and user interface 46 and further includes an input device 50 and a display 55. The processor 42 may be a microprocessor, micro-controller, digital signal processor, microcomputer, central processing unit, field programmable gate array, programmable logic device, state machine, analog circuitry, digital circuitry, and/or any device that manipulates signals (analog and/or digital) based on operational instructions. The memory 44 is a computer readable media and may be a single memory device or a plurality of memory devices. Such a memory device may be a read-only memory, random access memory, volatile memory, non-volatile memory, static memory, dynamic memory, flash memory, and/or any device that stores digital information. Note that when the processor 42 implements one or more of its functions via a state machine, analog circuitry and/or digital circuitry, the memory 44 storing the corresponding operational instructions is embedded with the circuitry comprising the state machine, analog circuitry and/or digital circuitry.

The processor 42 is coupled to the user interface 46 to receive data entered by a customer via input device 50. For example, input device 50 can include a combination of one or more of a mouse, keyboard, touch screen and other similar device. The processor 42 is further coupled to the user interface 46 to display the entered data and other information to the customer on the display 55. For example, the customer can enter the address of a license generation website 80 into the switch administration device 40 via the input device 50 and user interface 46 and the entered website address can be displayed to the customer on the display 55.

In addition, the processor 42 operates to execute instructions stored on memory 44 to perform various tasks. For example, the processor 42 can execute instructions that cause the switch administration device 40 to connect to the license generation website 80 in response to the customer entering the website address of the license generation website 80. As another example, the processor 42 can execute instructions that cause the switch administration device 40 to establish a connection with the switch 20 to download files and other data to the switch 20.

In an exemplary operation, in response to a customer entering the website address of the license generator website 80 into the switch administration device 40 via input device 50 and user interface 46, the processor 42 causes the switch administration device 40 to establish a communication session with the license generator 70 hosting the license generation website 80 via network 60. The website 80 pushes a log-in page to the switch administration device 40 which is displayed to the customer on display 55. After logging onto the website (i.e., entering a user name and password), in one embodiment, the website pushes a license purchase page to the switch administration device 40 which is displayed to the customer on display 55. The license purchase page includes various options for the customer to choose the type of license and number of licenses for one or more software applications.

For example, in one embodiment, the customer may desire a permanent license for a software application that was either pre-loaded onto the switch 20 or later installed on the switch 20. In another embodiment, the customer may desire a temporary license (hereinafter referred to as a “demo” license) to try out a particular software application that was either pre-loaded onto the switch or later installed on the switch 20.

The customer can then select, e.g., using input device 50, one or more licenses to purchase from the license purchase page. For example, the customer can select either a permanent or a demo license for a particular software application for a particular switch 20. As another example, the customer can select either a permanent or demo license for multiple software applications for a particular switch 20. As still a further example, the customer can select either a permanent or demo license for one or more software applications for one or more switches 20 managed by the customer. For each license that the customer purchases, the license generator 70 generates a unique authorization code, and the license generation website 80 pushes one or more pages that contain the authorization codes to the switch administration device 40 for display to the user via display 55 and possible storage within the memory 44. For example, in one embodiment, the authorization code is a 10-character alphanumeric string. However, it should be understood that the authorization code can be of any length and include any type of characters. It should also be understood that in other embodiments, the authorization code may be provided to the customer with the software application and/or switch 20, and therefore, the customer may be provided with the authorization code without requiring the customer to separately purchase a license.

Once the customer has the authorization code(s), the customer can continue the communication session with the license generation website 80 to generate a license file 30 for the license using the authorization code or can log-off and then log back on at a later time to generate the license file 30. To generate the license file 30, the license generation website 80 pushes a page to the switch administration device 40 that contains various fields for the customer to enter information for the license. For example, the page can contain a first field for the customer to enter the authorization code, a second field for the customer to enter the serial number of the switch 20 for which the license will be valid and the MAC address, e.g., a unique string of six integers, of the switch 20. Once the customer enters the serial number, MAC address and the authorization code into the switch administration device 40 using input device 50 and user interface 46 and clicks on a “submit” button or other similar button on the page, the switch administration device 40 transmits the entered serial number, MAC address and authorization code to the license generator 70.

The license generator 70 uses the entered information to generate a license file 30 containing a license key and license information associated with a license for a particular software application installed on a particular switch. In an exemplary embodiment, the license key is a 40-character string including string terminator character and is associated with a unique combination of the MAC address, serial number and authorization code. It should be understood that in other embodiments, the license key can be of any length and include any type of characters. In addition, in further embodiments, an encryption/decryption algorithm can be used to create and validate the license key from the license file 30.

In embodiments in which the customer purchases multiple licenses (i.e., a separate license for each of two or more software applications installed on particular switch 20 or a separate license for each of one or more software applications installed on two or more switches 20), the license file 30 can contain a separate license key for each license. For example, the customer can upload a CSV formatted file to the website 80 containing multiple entries of serial number, MAC address, authorization code. The license generator 70 can then generate a single license file 30 containing keys for all the entries in the input file. For example, each licensed application can have its own 40 character encrypted string in the license file 30. Multiple switch license keys can be stored in one license file 30, and hence help the customer propagate the license file 30 to multiple switches.

The license generation website 80 then transmits the license file 30 to the switch administration device 40 for storage within the memory 44 and/or propagation of the license file 30 to one or more switches 20. For example, when the customer desires to install the license file 30 on the switch 20, the customer instructs the switch administration device 40 to transmit the license file 30 to the switch 20. In an exemplary embodiment, the switch administration device 40 can use the file transfer protocol (FTP) or other similar protocol to transfer the license file 30 to the switch 20 and store the license file 30 within the switch 20.

Once the license file 30 is placed on the switch 20, the switch can internally validate one or more licenses for software applications installed thereon. In an exemplary embodiment, the switch 20 parses the license file 30, extracts the license keys that are applicable to that switch 20, validates the license keys and stores license information associated with the validated licenses within the switch 20 to enable the licensed software applications to execute properly on the switch 20. For example, the customer can apply the license file 30 to the switch 20 by issuing the following CLI command into the switch administration device 40 via input device 50 and user interface 46:

→ license apply.

The customer can then be prompted as follows:

→ The switch will reboot after the license is applied.

→ Are you sure you want to proceed(Y/N)?

If the customer enters ‘Y’, then the license file 30 is applied to (activated and validated on) the switch 20 and the switch 20 reboots.

In a further embodiment, the customer can then check whether the license was installed correctly after the reboot, by issuing the following CLI command provided to the switch 20 via input device 50 and user interface 46 of switch administration device 40:
→ show license info.
   The license information can then be retrieved from the switch 20 and displayed on the display 55 to the customer. The license information can include, for example, the name of the software application for which the license is valid, the type of license (permanent or demo) and the time period remaining for the license if the license is a demo license.

In addition, in accordance with still further embodiments of the present invention, the switch administration device 10 is also able to access and display information pertaining to each of the licenses on the license file 30 from switch 20. For example, in embodiments in which the license file 30 includes license keys and license information for multiple switches, the customer need only access one switch to obtain and display the license information for all switches. Therefore, customers do not have to keep track of licenses separately, since there is management interface within the switch 20 that enables the switch administration device 40 to access and display information of all licenses in the license file 30 (i.e., to which switches they are applicable, and for which software applications). As an example, the license information displayed to the customer on the display 55 can include the MAC address and name of software application for each license key contained within the license file 30. As such, the customer is able to look at the relevant license information from any switch provided all licenses are in one license file 30.

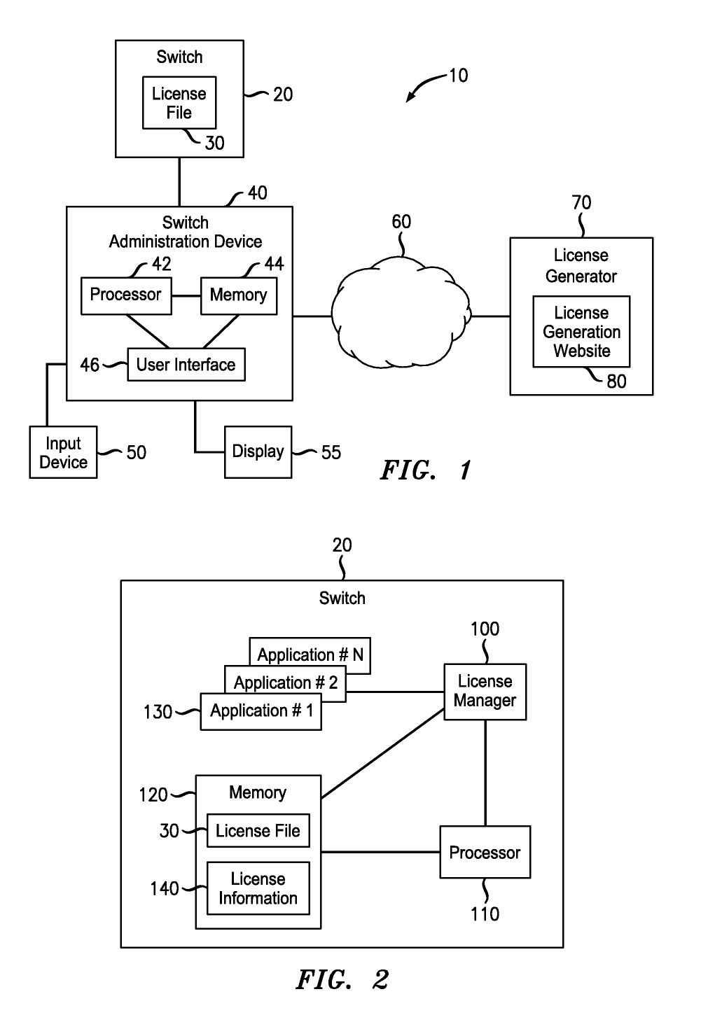

The details of the installation and validation of the license will now be described with reference to FIG. 2. FIG. 2 illustrates an exemplary switch 20 for validating one or more licenses for one or more software applications 130 installed on the switch, in accordance with embodiments of the present invention. The switch 20 includes a license manager 100, a processor 110, a memory 120 and software applications 130 (i.e., Application #1, Application #2 . . . Application #N). The license manager 100 is also a software application that includes instructions executable by the processor 110 to activate and validate a license for another software application 130 installed on the switch 20. Such processing can include, for example, validating the license file 30, informing licensed applications 130 of the validity of license and updating the memory 120 with license information 140 applicable to the license. The license manager 100 may be stored within memory 120 or another computer readable media.

The processor 110 may be a microprocessor, micro-controller, digital signal processor, microcomputer, central processing unit, field programmable gate array, programmable logic device, state machine, analog circuitry, digital circuitry, and/or any device that manipulates signals (analog and/or digital) based on operational instructions. The memory 120 is a computer readable media and may be a single memory device or a plurality of memory devices. Such a memory device may be a read-only memory, random access memory, volatile memory, non-volatile memory, static memory, dynamic memory, flash memory, and/or any device that stores digital information. Note that when the processor 110 implements one or more of its functions via a state machine, analog circuitry and/or digital circuitry, the memory 120 storing the corresponding operational instructions is embedded with the circuitry comprising the state machine, analog circuitry and/or digital circuitry.

In an exemplary operation, upon receiving the license file 30 via FTP or other transfer protocol, the switch 20 stores the license file 30 in memory 120. For example, in an exemplary embodiment, the license file 30 can be put in the /flash directory (memory 120) of the primary chassis management module (CMM) of the switch 20. To install a license for a particular software application 130, the switch 20 receives a command from the administrator to activate the license. As part of the license activation process through the command line, the license manager 100 will parse, validate, and write to the memory 120 license information 140 only of switches that match information from the license file, after which the switch 20 will reboot automatically. When the switch comes back up, license manger 100 reads the license information 140 from the memory 120 to validate the license. For example, if the license is a demo license, the license manager 100 determines if the license is valid based on the number of days remaining in the demo time period.

More particularly, as part of the activation process, the license manager 100 can look for a license file 30 stored within the memory 120. If a license file is not found, all of the restricted features of a particular software application 130 known to the license manager 100 can be blocked through the use of license manager application program interface (API), as described in more detail below. However, if a license file is found in the memory 120, the license manager 100 performs following checks on each license key in the file 30: (1) the restricted feature (software application 130) is known to the license manager; (2) the MAC address matches the base MAC address of the switch; (3) the serial number matches the serial number of the switch; (4) the license ID found in the license key is greater than or equal to an ID found in the memory 120 for the software application with a demo license (if there is no entry for the demo application in the memory 120, then this check is bypassed); and (5) the license type is either permanent or demo. With respect to check (4) above, every time a license file 30 is generated, the current system time becomes part of the license key and is common across all customers and all licensed applications. This time can be used as a license ID to check, as described above, if the switch is attempting to re-use a previously issued demo license.

If a license key passes all of the above checks, then the license information 140 associated with the license for that license key is written to the memory 120. For example, the license information 140 can include the license ID, license type, feature (i.e., the ID of the licensed software application) and the time remaining in days to evaluate the license (if the license type is demo, then the demo days remaining are updated once a day). If the license key does not pass all of the above checks, the license key is rejected and the respective software application will be blocked. In an exemplary embodiment, if a license is a demo license, then the number of evaluation days programmed in the memory 120 is equal to the demo time period for that application. The demo time period can be predetermined (i.e., a set amount of 60 days) or indicated in the license file 30.

Based on the validity of license, the license manager 30 adds an identifier of the software application to either a stored list (or log) of valid software applications or a stored list (or log) of invalid software applications. The stored lists can be maintained, for example, by memory 120. Licensed software applications 130 can access these lists through an application program interface (API) to the license manager 100 to take appropriate action. For example, if a license is invalid, in an exemplary embodiment, to prevent the customer from using the licensed feature, the software application 130 can spawn the task but not allow configuration of the software application.

If the license is a demo license, the license manager 100 further periodically (e.g., every day, every 6 hours or other time interval) checks whether the demo period has expired. For example, the license manager 100 can access the memory 120 to retrieve the number of days remaining in the demo period. If the number of days remaining is one or more, the license manager 100 can decrement the number of days remaining by one and store the new number of days remaining in the memory 120. However, if the number of days remaining retrieved from the memory 120 is zero, the license manager 100 can determine that the demo time period has expired. As another example, the license manager 100 can compare the demo activation time (i.e., time that the demo license was activated) with the current time to determine how many days have elapsed, and then compare the number of elapsed days with the number of days within the demo time period to determine if the number of elapsed days has exceeded the demo time period. As yet a further example, the license manage can initiate a counter with the number of days in the demo time period and then decrement the counter each day. When the counter reaches zero, the license manager 100 determines that the demo time period has expired. It should be understood that other algorithms and mechanisms can be used to determine whether the demo time period has expired and the present invention is not limited to any particular mechanism.

If the demo period has expired, the license manager 100 informs the respective software application 130, and the application 130 can then take appropriate action to deactivate the feature (application) 130. For example, if a license expires for a licensed application when the switch 20 is running, the license manager 100 may inform the respective application 130 through an IPC message. In response, the software application 130 for which the demo period has expired may lockup the CLI and prevent any further configuration for expired license feature, reboot the switch 20, perform a graceful shutdown of the task that handles the licensed application 130 or cleanup configuration of the licensed application but keep the task running in case the task handles two different licensed features.

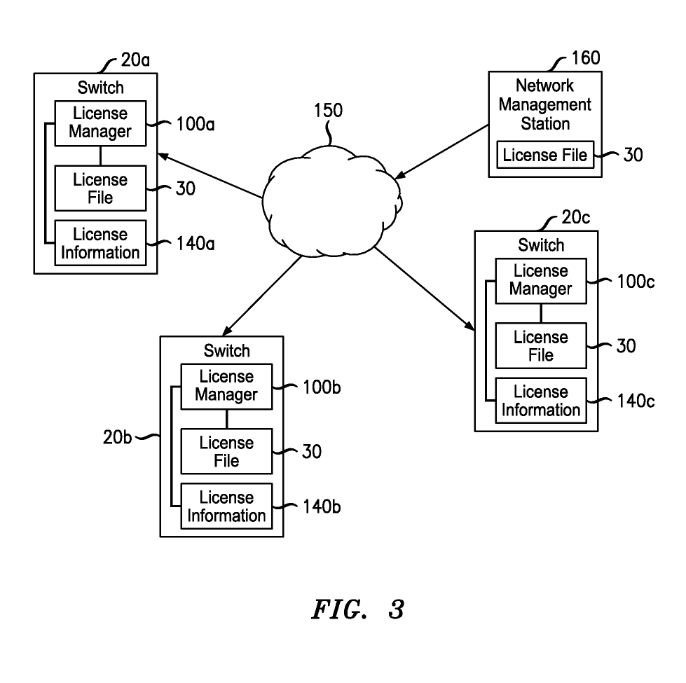

FIG. 3 illustrates a chassis environment for propagating licenses, in accordance with embodiments of the present invention. In FIG. 3, a network management station 160, which corresponds to the switch administration device 40 shown in FIG. 1, is coupled to manage multiple switches 20a, 20b and 20c within a network 150. The network management station 160 obtains a license file 30 containing multiple license keys for the switches 20a, 20b and 20c. For example, the license file 30 can contain a first license key for a first software application on a first switch 20a, a second license key for the first software application on a second switch 20b and a third license key for a second software application on a third switch 20c.

The network management station 160 can distribute the license file 30 to all switches 20a, 20b and 20c via network 150. The network 150 can be, for example, a local area network (LAN) or a wide area network (WAN) and can utilize any number of different communication protocols. Each switch 20a, 20b and 20c stores the license file 30 thereon and upon installation (applying) of the license file 30, the respective license manager 100a, 100b and 100c within each switch 20a, 20b and 20c, parses the license file 30 to extract the license keys applicable to that particular switch 20a, 20b and 20c. For example, switch 20a extracts the license key(s) that contain the MAC address and serial number of the switch 20a. Each switch 20a, 20b and 20c then validates the extracted license key(s) and stores respective license information 140a, 140b and 140c for the validated licenses thereon. For demo licenses, the license managers 100a, 100b and 100c can also send a trap to the switch management station 160 upon dynamic expiry of license.

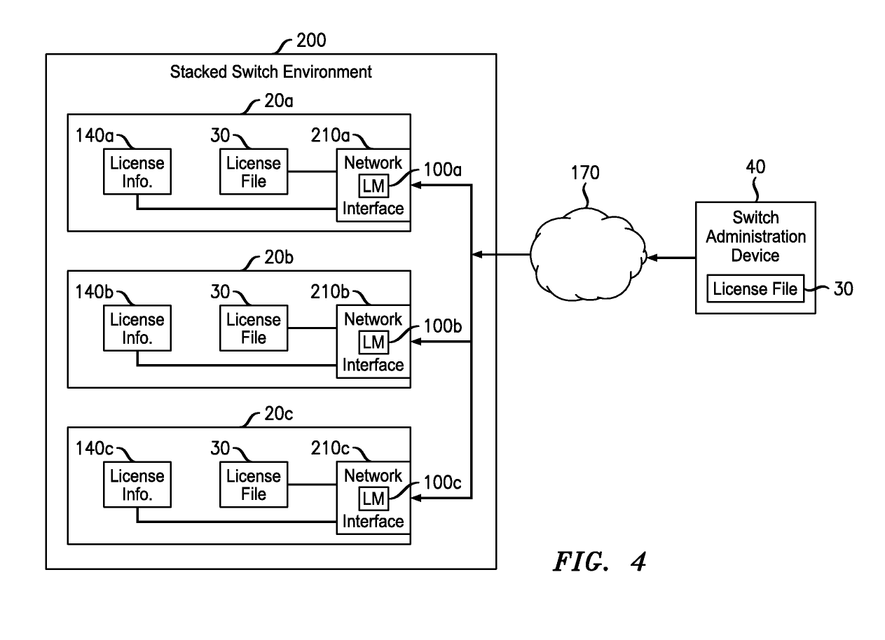

FIG. 4 illustrates a stacked switch environment 200 for propagating licenses, in accordance with embodiments of the present invention. In a stacked switch environment 200, multiple stackable switches 20a, 20b and 20c are coupled together and operate collectively as a single switch. To activate and validate a license for a particular software application in a stacked switch environment 200, there are multiple license keys in a single license file 30, each associated with a different one of the switches 20a, 20b and 20c in the stack. The switch administration device 40 can transmit the license file 30 with the multiple license keys to the stack 200 via network 170, and the license file 30 can then be propagated to all switches 20a, 20b and 20c of the stack through, for example, a file synchronization process. As shown in FIG. 4, the license managers 100a, 100b, 100c are resident on the network interface (NI) cards 210a, 210b and 210c of the stackable switches 20a, 20b and 20c. The license managers 100a, 100b and 100c will read the license file 30, extract and validate the appropriate license key for the particular switch 20a, 20b and 20c in the stack and store respective license information 140a, 140b and 140c for the validated licenses.

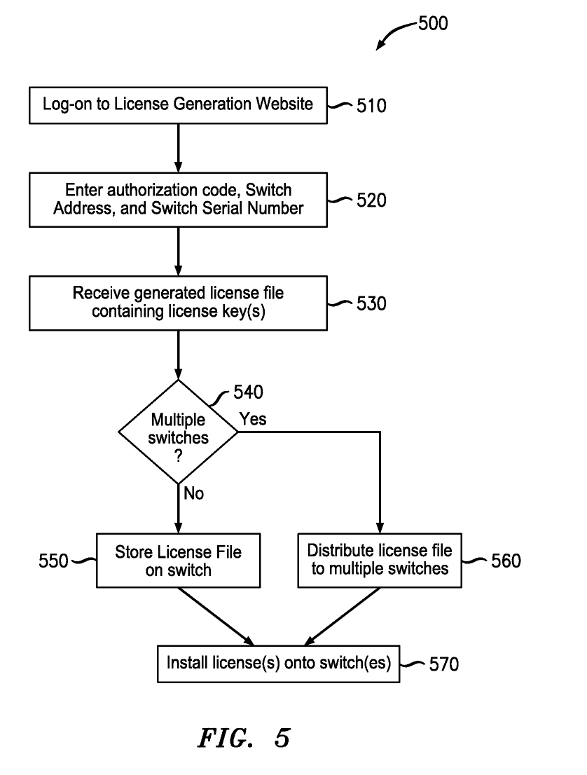

FIG. 5 is a flowchart illustrating an exemplary process 500 for obtaining and propagating one or more licenses. Initially, at 510, a customer, via a switch administration device, logs-on to the license generation website, and at 520, the customer enters a respective authorization code, switch MAC address and switch serial number for each license. The authorization code can be provided by the license generation website upon purchase of a license by the customer or can be provided to the customer with the purchase of the switch, part of the switch and/or software application associated with the license. At 530, a license file containing the license key(s) for each license is generated and provided to the switch administration device. At 540, a determination is made whether the license file contains license keys for multiple switches. If not, at 550, the switch administration device stores the license file on a single switch. If so, at 560, the switch administration device distributes the license file to multiple switches. At 570, the switch administration device instructs the switch(es) to install the license(s) thereon.

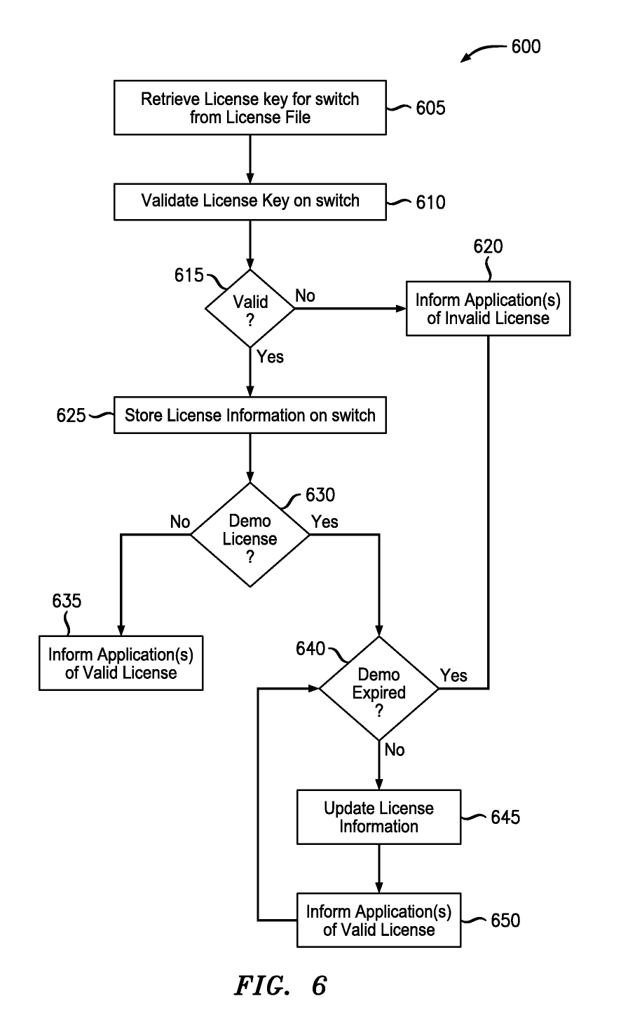

FIG. 6 is a flow diagram illustrating an exemplary process 600 for installing and validating a license on a switch, in accordance with embodiments of the present invention. At 605, a license manager within the switch retrieves a license key for a particular software application installed on the switch from the license file. At 610, the license manager validates the license key to determine, at 615, whether or not a valid license exists for the particular software application. If the license is not valid, at 620, the license manager informs the particular software application that the license is not valid. However, if the license is valid, at 625, license information associated with the license is stored on the switch.

At 630, a determination is made whether the license is a demo license. If not, at 635, the license manager informs the software application that the license is valid. If so, at 640, a determination is made whether the demo period has expired. If not, at 645, the license information is updated with the amount of time remaining in the demo period, and at 650, the software application is informed that the license is valid. The process repeats at 640 until the demo period expires. Once the demo period expires, the process returns to 620, where the software application is informed that the license is not valid.

As will be recognized by those skilled in the art, the innovative concepts described in the present application can be modified and varied over a wide rage of applications. Accordingly, the scope of patents subject matter should not be limited to any of the specific exemplary teachings discussed, but is instead defined by the following claims.

We claim:

1. A computer readable media within a switch having computer executable instructions thereon to perform a method of validating a license, the method comprising:
receiving a license file generated to provide a license for a software application installed on the switch, the license file containing a license key and license information for the switch;
installing the license file on the switch to activate the license;
validating the license internally on the switch using the license key within the license file; and
storing the license information associated with the license on the switch.

2. The computer readable media of claim 1, wherein the license file contains multiple license keys, each for use in validating a respective license for each of a plurality of different software applications installed on the switch.

3. The computer readable media of claim 1, wherein the license file contains multiple license keys, each for use in validating a respective license for each of a plurality of different switches.

4. The computer readable media of claim 3, wherein the validating the license and storing the license information further comprise:
validating internally on the switch only the license for the switch using the license key associated with the switch within the license file; and
storing only the license information associated with the license for the switch on the switch.

5. The computer readable media of claim 3, wherein the method further comprises:
enabling the license information for each the licenses associated with each of the plurality of different switches within the license file to be viewed from the switch.

6. The computer readable media of claim 3, wherein the receiving the license file further comprises:
receiving the license file from a switch administration device via a network.

7. The computer readable media of claim 1, wherein the method further comprises:
informing the software application of the validity of the license by adding an identifier for the software application to a stored list of valid software applications accessible to the software application via an application program interface.

8. The computer readable media of claim 1, wherein the method further comprises:
if the license is a demo license and the license information includes a time period within which the demo license is valid:
periodically determining whether the time period has expired; and
if so, informing the software application of the expiration of the demo license.

9. A switch having a software application installed thereon for which a license is needed, the switch comprising:
a processor for receiving a license file generated to provide the license for the software application, the license file containing a license key and license information, the processor further for installing the license file on the switch to activate the license and validating the license using the license key within the license file; and
a memory for storing the license information associated with the license.

10. The switch of claim 9, wherein the license file contains multiple license keys, each for use by the processor in validating a respective license for each of a plurality of different software applications installed on the switch.

11. The switch of claim 9, wherein the license file contains multiple license keys, each for use in validating a respective license for each of a plurality of different switches, and wherein the processor further validates only the license for the switch using the license key associated with the switch within the license file and stores only the license information associated with the license for the switch in the memory.

12. The switch of claim 11, wherein the processor further provides the license file to a switch administration device via a network to enable the license information for each the licenses associated with each of the plurality of different switches within the license file to be viewed.

13. The switch of claim 11, wherein:
the switch is a switch modular chassis;
the switch is coupled to a network to receive the license file from a network management station coupled to multiple switch modular chassis via the network; and
the license file is provided by the network management station to the multiple switch modular chassis.

14. The switch of claim 11, wherein the switch is a stackable switch configured to operate with additional stackable switches as a single switch, and further comprising:
a network interface card coupled to a network to receive the license file from a switch administration device and coupled to the additional stackable switches to provide the license file to the additional stackable switches.

15. The switch of claim 9, wherein the license key is associated with a unique combination of a switch network address, switch serial number and a license number for the license.

16. The switch of claim 15, wherein the license key is a 40 character encrypted string.

17. A method for obtaining licenses for a software application installed on multiple switches within a network, comprising:
accessing, by a processor, a license generation website for the licenses;
uploading, by the processor, a file containing multiple entries to the website, each of the entries including a respective authorization code for each of the multiple switches;
receiving a single license file containing a respective license key for each of the entries in the file, each of the license keys for use in validating a respective license for the software application on each of the multiple switches; and
distributing the license file to the multiple switches for installation and activation of the licenses thereon.

18. The method of claim 17, wherein each of the license keys is associated with a unique combination of a switch network address, switch serial number and a license number for the license.

19. The method of claim 17, wherein the distributing the license file to the multiple switches further includes:
distributing the license file to multiple switch modular chassis via the network.

20. The method of claim 17, wherein the distributing the license file to the multiple switches further includes:
distributing the license file to multiple stackable switches configured to operate together as a single switch.
